(19) United States
(12) Patent Application Publication
(10) Pub. No.: US 2025/0217897 A1
(43) Pub. Date: Jul. 3, 2025

(54) SYSTEM AND METHOD FOR DIGITAL SIGNATURE OF IMAGE-BASED CHECK DEPOSITS AND REAL-TIME REVIEW THEREOF

(71) Applicant: DIGITAL FIRST HOLDINGS LLC, Atlanta, GA (US)

(72) Inventors: Muhammad Salmaan, Milton (CA); Ryan Guo, Waterloo (CA); Jennifer Kira Lithgow, Newmarket (CA); Jeongyeon Park, Waterloo (CA)

(21) Appl. No.: 18/400,959

(22) Filed: Dec. 29, 2023

(51) Int. Cl. G06Q 40/12; G06T 1/00

(52) U.S. Cl. CPC G06Q 40/128; G06T 1/0042; G06T 2200/24

(57) ABSTRACT

An image capture device coupled to a computing device generates scanned images of customer checks. In operation, a scanned image is generated of a rear side of a check to be deposited that is provided to the image capture device during a current check deposit transaction. A first user interface display is provided via a customer-facing user interface that shows the scanned image of the rear side of the check to be deposited and allows the customer to generate a digital marking for insertion onto the scanned image of the rear side of the check. The scanned image of the rear side of the check is modified to include the digital marking. A teller reviews and approves the digital marking (e.g., signature) in real time during the current check deposit transaction. The current check deposit transaction is completed when the teller approves the digital marking.

### FIELD

This disclosure relates generally to banking systems and, more particularly, to a system and method for digital signature of image-based check deposits and real-time review thereof.

### BACKGROUND

A remote deposit capture device captures check image data which is representative of checks to be deposited with a financial institution, such as a bank. As an example, a remote check image capture device located at a teller station of a bank branch may include a check scanner that allows a bank teller to scan an image of a check to be deposited by a bank customer. As another example, a remote check image capture device may include a mobile device with a built-in digital camera for capturing an image of a check to be deposited. As yet another example, a remote check image capture device may include an automated teller machine (ATM) at which an image of a check to be deposited can be captured.

Presently, a customer physically endorses (signs) the back of a check before providing the endorsed check to the remote deposit capture device for scanning. The signature is typically added to the check either before going to the bank or out of sight of the teller at the bank. This requires further processing later, e.g., to review and approve the signature, and can lead to difficulties in transferring funds to the customer's account if the signature is illegible or otherwise not acceptable. In some cases, an extended hold may be placed on the deposited check if the signature is called into question, leading to delays in accessing the funds. Furthermore, the customer has no way to annotate the check using markup tools or otherwise capture information about the check for future use.

The present disclosure describes a technical solution that solves the above-noted technical problems.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system for digital marking of image-based check deposits according to the present disclosure;

FIG. 2 is a flowchart of a method for digital marking of image-based check deposits according to the present disclosure; and

FIG. 3 is a diagram of the user interface for use with the system and method for digital marking of image-based check deposits according to the present disclosure.

### DETAILED DESCRIPTION

In the present disclosure, like reference numbers refer to like elements throughout the drawings, which illustrate various exemplary embodiments of the present disclosure.

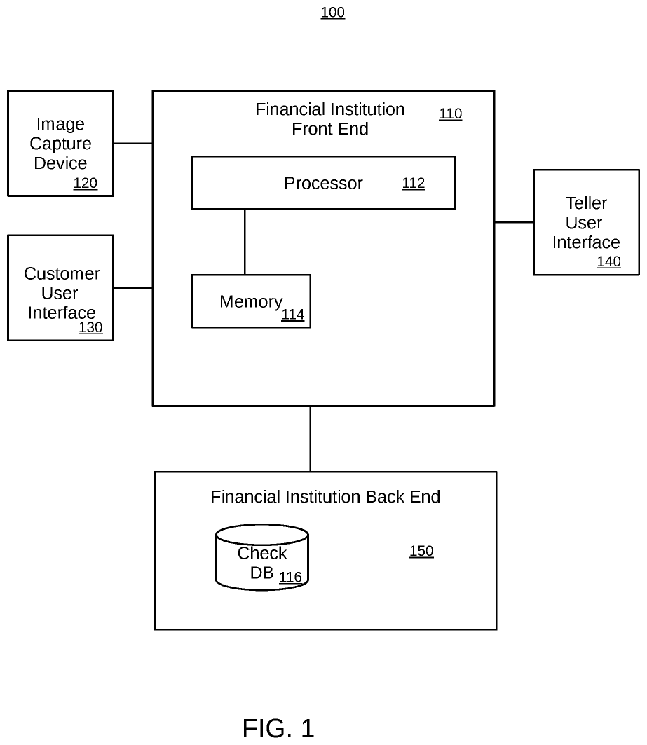

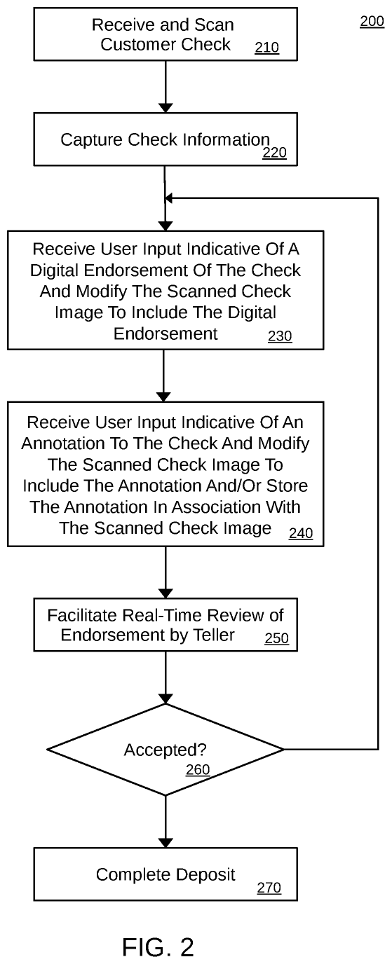

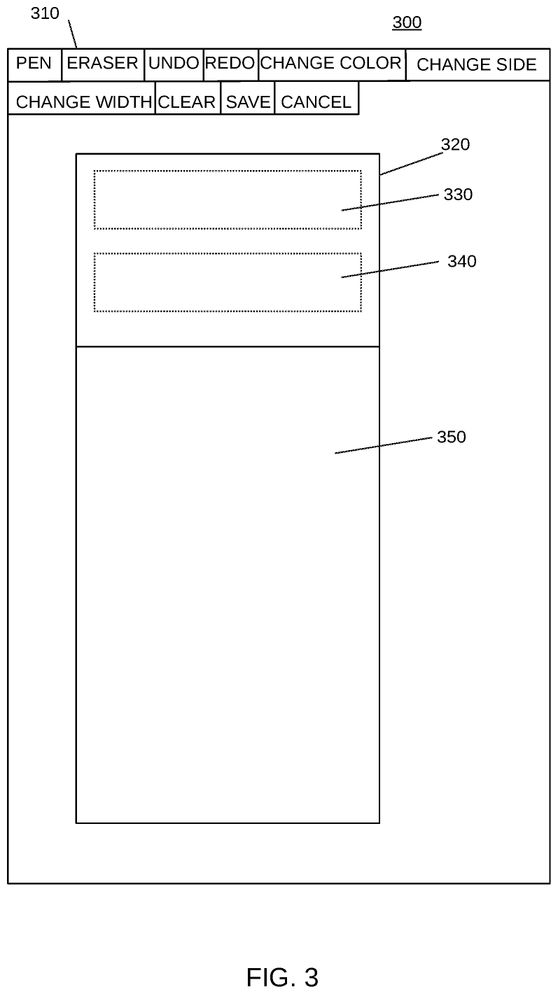

Referring now to FIG. 1, a system 100 for digital marking (e.g., signature) of image-based check deposits includes a front end portion 110 for a particular financial institution (bank) that is coupled to a bank end portion 150. The front end portion 110 is a computing device that includes a processor 112 and an instruction memory 114. The processor 112 operates based on instructions stored in instruction memory 114, as explained below with respect to FIGS. 2 and 3. The instruction memory 114 may include volatile and nonvolatile portions, with the nonvolatile portions being a non-transitory computer-readable storage medium as known in the art for storing the instructions executable by processor 112. The bank end portion 150 includes a check database 116 which may be a non-volatile memory configured to store check images. An image capture device 120 and a customer user interface 130 are coupled to the front end portion 110 (and are under the control of processor 112) for customer access and a teller user interface 140 (also under the control of processor 112) is coupled to the front end portion 110 (also under the control of processor 112) for use by the teller. The image capture device 120 and the customer user interface 130 may be provided at a live teller station or as part of an interactive teller machine. The teller user interface 140 may be provided at the teller side of a live teller station or as part of a remote interface for an interactive teller machine. The customer user interface 130 and the teller user interface 140 each include a display portion and a user input portion. The user input portion may be provided via touchscreen functionality provided by the display portion and operated via a customer's touch motion or via a stylus used with the display portion.

System 100 provides for enhanced communication between a customer and a teller. Referring now to the flowchart 200 in FIG. 2, when a customer desires to deposit a check, either directly at a live teller station or via an interactive teller machine, the check is inserted into the image capture device 120 at a first step 210. The processor 112 in the front end portion 110 receives the digital check image and processes the check image at step 220 to capture the necessary information from a front side of the check. The customer is then provided with an image of the scanned rear side of the deposited check (when the check is made out to the customer by a third party for deposit) via customer user interface 130 at step 230 for endorsement via the user interface display 300 shown in FIG. 3 as discussed below. Alternatively, the customer may be presenting his own check for deposit, which requires a signature on both the front side and the rear side of the check, and in which case, as explained more fully below, the customer can use the tools provided via the user interface display 300 to switch between the scanned rear and front sides of the imaged check. User input indicative of digital markings (such as signatures) of the check by the customer in the appropriate place (or places) on the check are received via the user interface display 300, and the scanned image is modified at step 230 to include the digital marking (via processing at processor 112). Optionally, at step 240, user input indicative of annotation(s) made by the customer to the check are received via the user interface display 300 and the scanned check image is further modified to include the annotations and/or the annotations are saved separately from the scanned check image but linked thereto. Processor 112 causes the annotated check image to be saved in the check database 116 for future reference by the customer and/or for use in other administrative applications, e.g., processing at the financial institution back end 150.

The digitally endorsed and optionally annotated check image is then provided to the teller user interface 140 to facilitate real-time review by the teller at step 250. The teller decides in real time whether to accept the check at step 250, and if accepted, the deposit is completed at step 270. If the teller does not accept the customer signature, processing returns to step 230 to allow the customer to attempt to digitally sign the check a second time. In some cases, the teller may also be allowed to end the transaction at this point if there is any indication of fraud—e.g., if the check is not made out to the customer.

As shown in FIG. 3, the system 100 provides the customer with an intuitive and user-friendly user interface display 300 (FIG. 3) via customer user interface 130 that allows for digital signing, in an endorsement area 340, of a scanned image 320 of a check to be deposited, where such signing can occur at the time of deposit. Another area 330 on the back of the scanned check image 320 is provided for a restricted endorsement (e.g., “For Deposit Only”) or other type of non-legal annotation (e.g., a note about the source or purpose of the check, such as “my birthday gift from Dad”). In a further embodiment, pre-defined digital endorsements are selectable via a drop-down menu. A third area 350 of the scanned check is reserved for bank use as a security screen and to provide security markings.

The controls 310 in user interface display 300 include a pen tool, an eraser tool, an undo button, a redo button, a change color button (with a drop-down menu for selecting colors), a change side tool, a change width tool, a clear button, a save button, and a cancel button. The pen tool enables a customer to sign a scanned check electronically, replacing any need for a manual signature. It may operate in conjunction with a separate stylus (or the equivalent) provided with the customer user interface 130 or may be a function provided by a touchscreen that forms part of the customer user interface 130. The change color tool provides an assortment of colors for annotations, allowing a customer with the ability to mark the scanned checks with various shades, facilitating better organization and categorization. The change side tool allows a customer to switch between the rear view as shown in FIG. 3 and a front view (not shown) so that the customer can annotate a front part of the check or sign the front part of the check (when it is a check issued from an account of the customer). The change width tool allows a customer to vary the thickness of annotations and thereby provide clearer and more visible markings on the check image. The eraser tool enables a customer to correct any mistakes or undo annotations that were made in error, further improving the user experience. Moreover, redo/undo buttons are available, ensuring that a customer can easily manage and modify their annotations with precision.

Overall, the system 100 provides a customer with the ability to digital sign and annotate scanned check images and provide the signed/annotated check images to a teller via the teller user interface 140. This streamlines communication between the customer and the teller. For example, by providing the teller with access to the annotated check image, along with any optional notes provided by the user, for the teller is able to better understand the context of the deposit.

The system and method of the present disclosure provides signature capability within the customer user interface itself, instead of via a separate application as is currently done by other digital signature solutions. The disclosed system and method provide significant value by overcoming the inherent challenges and inefficiencies in a traditional check deposit process based on physical marking via pen-based signatures. By incorporating digital signatures and a customizable markup feature, the disclosed system and method offers a range of benefits that can enhance the overall banking experience for customers. The check deposit process is streamlined by eliminating the need for manual signatures, resulting in faster and more secure transactions. There is no reliance on physical paperwork, thereby reducing the risk of signature forgery and ensuring the authenticity of each check deposit. By allowing the teller to confirm the signature on the check in real time by a comparison with the on-file signature for the customer, the possibility of fraud is reduced. In the disclosed system and method, the ability to save annotated check images for future reference or for use in other applications is provided, adding convenience and organization to the customer's financial management process. Customers may maintain digital records of their own check deposits, simplifying accounting tasks and reducing paperwork. Furthermore, communication between a teller and a customer is improved by access to the annotated check image and optional customer notes, fostering a more seamless and efficient collaboration between customers and bank tellers, and leading to quicker issue resolution and enhanced customer satisfaction.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A system for providing a digital marking on a scanned image of a check, comprising:
a computing device comprising a processor and a non-transitory computer-readable storage medium;
an image capture device coupled to the computing device, the image capture device being configured to generate scanned images of checks received at the system;
a customer-facing user interface coupled to the computing device; and
wherein the non-transitory computer-readable storage medium comprises executable instructions that, when executed by the processor, cause the processor to:
generate a scanned image of a rear side of a check to be deposited, wherein the check is received at the image capture device during a current check deposit transaction;
provide a first user interface display via the customer-facing user interface that shows the scanned image of the rear side of the check to be deposited and allows a customer to provide input for generating a digital marking for association with the scanned image of the rear side of the check to be deposited;
modify the scanned image of the rear side of the check to be deposited to include the digital marking;
facilitate review of the digital marking by a teller in real time during the current check deposit transaction; and
complete the current check deposit transaction on the condition that the teller approves the digital marking.

2. The system of claim 1, comprising:
a teller-facing user interface coupled to the computing device,
wherein the non-transitory computer-readable storage medium includes executable instructions that, when executed by the processor, cause the processor to:
provide a second user interface display via the teller-facing user interface that shows the modified scanned image of the rear side of the check to be deposited.

3. The system of claim 1, wherein the non-transitory computer-readable storage medium includes executable instructions that, when executed by the processor, cause the processor to generate a scanned image of a front side of the check to be deposited provided by the customer to the image capture device during the current check deposit transaction.

4. The system of claim 3, wherein the non-transitory computer-readable storage medium includes executable instructions that, when executed by the processor, cause the processor to capture information from the scanned image of the front side of the check to be deposited provided by the customer to the image capture device during the current check deposit transaction.

5. The system of claim 1, wherein the non-transitory computer-readable storage medium includes executable instructions that, when executed by the processor, cause the processor to provide the first user interface display via the customer-facing user interface that shows the scanned image of the rear side of the check to be deposited and that allows the customer to provide input for generating an annotation to the check to be deposited.

6. The system of claim 5, wherein the annotation is a restrictive endorsement.

7. The system of claim 5, wherein the annotation is a note about a source of the check.

8. The system of claim 5, wherein the annotation is a note about a purpose of the check.

9. The system of claim 5, wherein the non-transitory computer-readable storage medium includes executable instructions that, when executed by the processor, cause the processor to modify the scanned image of the rear side of the check to be deposited to include the annotation.

10. The system of claim 3, wherein the non-transitory computer-readable storage medium includes executable instructions that, when executed by the processor, cause the processor to save the modified scanned image of the rear side of the check to be deposited and the scanned image of the front side of the check to be deposited in a check database upon completion of the current check deposit transaction.

11. A method for providing a digital marking on a scanned image of a check, comprising:
generating a scanned image of a rear side of a check to be deposited that is received at an image capture device during a current check deposit transaction;
providing a first user interface display via a customer-facing user interface that shows the scanned image of the rear side of the check to be deposited and allows a customer to provide input for generating a digital marking for association with the scanned image of the rear side of the check to be deposited;
modifying the scanned image of the rear side of the check to be deposited to include the digital marking;
facilitate review of the digital marking by a teller in real time during the current check deposit transaction; and
completing the current check deposit transaction on the condition that the teller approves the digital marking.

12. The method of claim 11, comprising:
providing a second user interface display via a teller-facing user interface that shows the modified scanned image of the rear side of the check to be deposited.

13. The method of claim 11, comprising generating a scanned image of a front side of the check to be deposited provided by the customer to the image capture device during the current check deposit transaction.

14. The method of claim 13, comprising capturing information from the scanned image of the front side of the check to be deposited provided by the customer to the image capture device during the current check deposit transaction.

15. The method of claim 11, providing the first user interface display via the customer-facing user interface that shows the scanned image of the rear side of the check to be deposited and that allows the customer to provide input for generating an annotation to the check to be deposited.

16. The method of claim 15, wherein the annotation is a restrictive endorsement.

17. The method of claim 15, wherein the annotation is a note about a source of the check.

18. The method of claim 15, wherein the annotation is a note about a purpose of the check.

19. The method of claim 15, comprising modifying the scanned image of the rear side of the check to be deposited to include the annotation.

20. The method of claim 13, comprising saving the modified scanned image of the rear side of the check and the scanned image of the front side of the check to be deposited in a check database upon completion of the current check deposit transaction.
